(19) United States
(12) Patent Application Publication
(10) Pub. No.: US 2011/0136679 A1
(43) Pub. Date: Jun. 9, 2011

(54) Imprinted Array

(75) Inventors: John Huntriss, Leeds (GB); Helen Picton, Leeds (GB)

(73) Assignee: Leeds Teaching Hospitals NHS Trust, Leeds (GB)

(21) Appl. No.: 12/678,088

(22) PCT Filed: Sep. 12, 2008
(86) PCT No.: PCT/GB08/03115

§ 371 Date: Feb. 22, 2011

(30) Foreign Application Priority Data
Sep. 14, 2007 (GB) 0717860.1

(51) Int. Cl. C40B 30/00; C40B 40/06

(52) U.S. Cl. 506/7; 506/16

(57) ABSTRACT

There is described a gene expression array comprising more than one imprinted gene and one or more control genes for the diagnosis of human epigenetic diseases resulting from assisted reproduction or the disruption.

### FIELD OF THE INVENTION

The present invention relates to a kit and method for detecting and/or screening for the presence of diseases, such as epigenetic disruption and associated diseases, and for assessing the risk of epigenetic disruption.

### BACKGROUND

Microarray analysis of gene expression typically yields expression data from thousands of genes, as the arrays that are used usually cover the whole or most of the genome (typically 12,000 to 30,000 genes on these arrays). This means that much data is generated that may not be of particular interest to the researcher or diagnostic team. In other words, the ‘extra’ data is not directly relevant to the project, hence time and effort is wasted performing complex data analysis. Therefore, by creating a focused array that is specific to a restricted number of genes, for example, genes that are grouped by sharing a common function, data handling is much easier and more straightforward. Furthermore, this would allow more rapid and efficient generation of results.

Genomic imprinting is a genetic phenomenon by which certain genes are expressed in a parent of origin specific manner. Forms of genomic imprinting have been demonstrated in insects, flowering plants and mammals, such as humans.

In diploid organisms, such as humans, somatic cells possess two copies of the genome. Each autosomal gene is therefore represented by two copies, or alleles, with one copy inherited from each parent at fertilization. For the vast majority of autosomal genes, expression occurs from both alleles simultaneously. However, a small proportion (<1%) of genes are imprinted, meaning that gene expression occurs from only one allele, i.e. the expressed allele is dependent upon its parental origin.

Importantly, imprinted genes have diverse functions but exhibit a unique expression mechanism that makes them susceptible to being disrupted by cellular ‘environmental’ factors. This therefore makes them ideal as biomarkers or indicators of abnormality within a cell or tissue. Thus, imprinted genes can be markers of early cancer and induced cellular stresses observed in oocytes/embryos during in-vitro fertilization procedures.

U.S. Pat. No. 6,235,474 describes a method and a kit for measuring abnormalities in imprinting in the development of cancer The imprinting can be abnormally on or can be abnormally off. In those cases where the particular gene that is being examined is normally imprinted, but in the disease state is abnormally not imprinted, the present invention is designed to detect the “loss of imprinting” thereby indicating that the disease may be present. However, the method/kit of U.S. Pat. No. '474 measures the loss of imprinting for a single gene, therefore, whilst this may have some benefits, it clearly has severely limited practical use for the analysis of more complex gene systems.

Epigenetic disruption in mammalian cell, such as a human cell, can lead either to an increase of expression of an imprinted gene or a decrease or even silencing of the imprinted gene. The processes involved may include relaxation of imprinting, gain of imprinting, promoter switch to a non-imprinted isoform, or from a non imprinted isoform to an imprinted one or another form of epigenetically-mediated silencing or activation of the imprinted gene. Furthermore, due to i) the reciprocal expression modes of certain imprinted genes (e.g. H19, IGF2), ii) the fact that expression of certain imprinted genes is accompanied or regulated by expression of imprinted antisense transcripts, and iii) that imprinted genes work in networks, it is likely that epigenetic disruption in a cell will be reflected by expression changes of more than one imprinted gene transcript. Tables I, II and III detail the aberrant regulation and expression of imprinted gene transcripts following assisted reproductive techniques (gametes and embryos), in embryonic stem cells and following somatic cell nuclear transfer to produce cloned embryos. It therefore follows that if epigenetic disruption is induced for example in embryos by a given Assisted Reproductive Technology (ART) procedure, then the associated up-regulation or down-regulation of imprinted gene expression will be detectable using a sufficiently sensitive imprinted gene expression array that is adequately controlled. The epigenetically susceptible imprinted genes therefore will act as biomarkers of epigenetic disruption.

We have now found that by utilising a set of specific imprinted genes in a controlled context of gene expression microarray we are able to provide a workable array and a method of diagnostic screening for disease states.

### SUMMARY OF THE INVENTION

Thus, according to a first aspect of the invention we provide a gene expression array comprising more than one imprinted gene and one or more control genes. The number of imprinted genes may vary, but generally, they will make up from 60 to 80% of the total array, preferably from 65 to 75%, e.g. 72%. The more than one imprinted genes may be selected from any known/predicted human imprinted genes across the imprinted regions on human chromosomes 1, 6, 7, 11, 12 13, 14, 15, 18, 19 and 20 and X. The choice of the imprinted gene(s) will be dependent upon, inter alia, the disease type intended to be diagnosed. Thus, for example, the imprinted gene may be selected for the diagnosis of human epigenetic diseases resulting from assisted reproduction or the disruption of imprinted gene expression caused by assisted reproduction and/or in vitro culture of mammalian gametes, embryos, stem cells, somatic cell lines and therapeutic stem cells, birth defects, mental retardation, obesity, gross motor disturbances, diabetes, molar pregnancy, disorders of genomic imprinting, other epigenetic diseases.

When the gene expression array according to the invention is used for the diagnosis of disease resulting from assisted reproduction and/or in vitro culture, the imprinted gene may be more than one of H19, KCNQ1OT1, SNRPN, PEG1/MEST and IGF2.

When the gene expression array according to the invention is used for the diagnosis of disease resulting from the disruption of imprinted gene expression in assisted reproduction and/or in vitro culture of mammalian gametes, embryos and/or stem cells, the imprinted gene may be more than one of H19, IGF2, MEG1, H19, KCNQ1OT1, SNRPN and PEG1/MEST.

The one or more control genes, will preferentially be a non-imprinted control gene which is positioned within or adjacent to the imprinted region. In addition, other control genes which may be mentioned are “housekeeping” control genes, i.e. ubiquitously expressed genes. The number of control genes may vary, but generally, they will make up from 10 to 20% of the total array, preferably from 12 to 15%, e.g. 14%. The control genes will predominantly be made up of imprint region controls, preferably, the imprint region control will comprise 50% or more of the total control gene population.

The array may optionally include one or more epigenetic regulator genes. When one or more epigenetic regulator genes is present, the number of optional epigenetic regulators may vary, but generally, they will make up from 5 to 15% of the total array, preferably from 8 to 12%, e.g. 10%. The number of control genes may also vary depending upon the presence of one or more epigenetic regulator genes.

According to a further aspect of the invention we provide a method of detecting the presence of a disease in a subject which comprises obtaining a biological sample from the subject and screening the sample for abnormal imprinting or abnormal expression of epigenetic regulators in one or more gene simultaneously. The method of the invention preferably comprises the use of an array as hereinbefore described.

An Imprinted Gene Expression Array according to the invention is advantageous for, inter alia, the following reasons:
Imprinted gene expression is disrupted in cancer (Table I), human assisted reproduction (Table II), mammalian in vitro embryo manipulation and stem cell technologies (Table III), and epigenetic diseases.
Imprinted genes are uniquely susceptible to epigenetic disruption
Use imprinted genes themselves as Bio-markers of epigenetic disruption
Array can show epigenetic disruption across 11 or more chromosomes
Networked expression mode enhances likelihood of detection of epigenetic disruption. Specific inactivation of six imprinted genes has been reported in in vitro cell cultures exposed to cellular stress and this also occurs in tumours (Pantoja et al., 2005). Other papers support these observations of imprinted genes working in networks (Varrault et al., 2006). If the expression of imprinted gene Zac1 is inactivated, so are other imprinted genes Igf2, H19, Cdkn1c, and Dlk1.
Array features transcripts from complex imprinted loci, (antisense transcripts etc.)
100 genes only on array-reduces complexity of bioinformatics
Bespoke array-allows expression analysis of all imprinted genes (n=70) arising from single embryo or small biopsy (less than 100 cells)
Alternatives such as bisulphite sequencing analysis limited to one gene/region for similar numbers of cells.
The pattern of disrupted imprinted gene expression revealed by the array will reveal the likely origin of the causative epigenetic mutation.

An Imprinted Gene Expression Array according to the invention has utility both as a research tool and has commercial applications/markets:
i) ART Industry. Screening for safety of existing and emerging human Assisted Reproductive Technologies to minimize epigenetic dysregulation as represented by a disruption of genomic imprinting following in vitro fertilization treatment and thus to minimize downstream epigenetic diseases. The array has been used successfully on single human embryos and oocytes—an essential requirement for this analysis. At this level of sensitivity, alternative techniques (e.g. bisulphite sequencing) can only assess epigenetic regulation at single or a restricted number of loci.
ii) Screening Human Stem Cells (embryonic, germ and adult types) and therapeutic differentiated cell derivatives thereof to ensure that disruption of imprinting (for example, deregulation of imprinting induced by extended cell-culture), is not a feature of the stem cell derivatives that are transplanted into the human body.
iii) Diagnostic or Research Product. For studying human imprinted diseases and epigenetic disorders, epigenetic mechanisms. For diagnostic investigation of disruption of imprinted gene expression in human imprinted diseases (Prader-Willi syndrome, Beckwith-Wiedemann syndrome, Angelman syndrome, Wilm's Tumour, Silver-Russell syndrome, Transient Neonatal Diabetes Mellitus, Rett's Syndrome, Molar pregnancies). Use in conjunction with traditional genomic diagnostic techniques to identify the genetic/epigenetic lesion and the genes that are affected in the patient.
iv) General Research Tool. Analysis of epigenetic regulation in experimental cells/animals, stem cell lines and, somatic cell lines and/or therapeutic stem cells that have undergone specific treatments/interventions that may disrupt epigenetic systems/imprinted gene expression (e.g. gene knockouts experiments, RNA interference experiments, somatic cell nuclear transfer (cloning) or similar procedures).

### DETAILED DESCRIPTION OF THE INVENTION

The invention will now be described, by way of example only, with reference to the accompany tables and figures.

### Example 1

### Description of Array

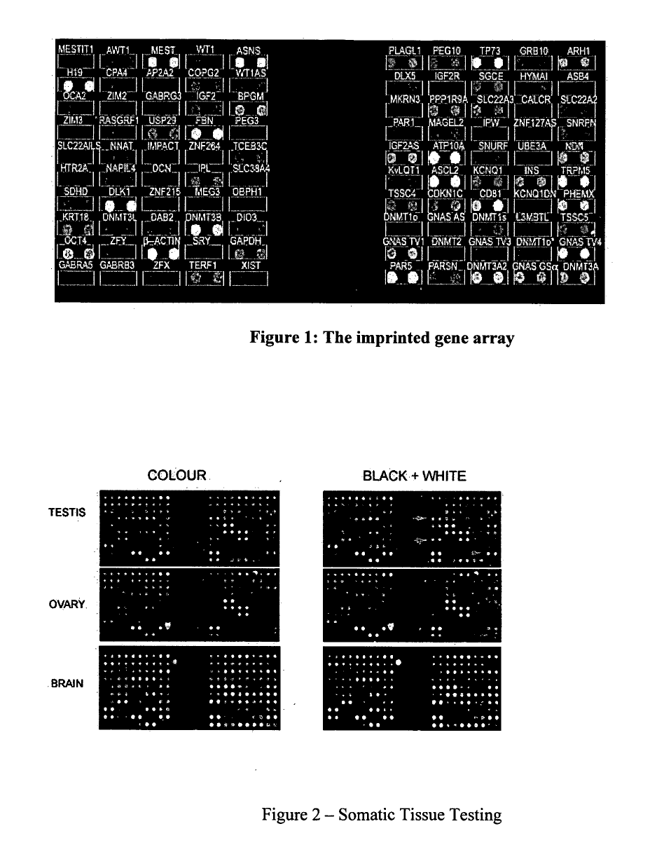

FIG. 1 is an imprinted gene array according to the invention. The array is a focused oligonucleotide microarray, specifically representing the human imprinted genes. The array features 60-mer oligonucleotides designed to be specific for these genes.

### Example 2

Somatic Tissue Testing. The array has been extensively tested in mRNAs derived from a range of human somatic tissue. Testis and ovary and brain as compared to a reference multi-tissue mRNA sample are shown in FIG. 2. Three differentially expressed genes are arrowed in the testis sample as examples.

### Example 3

### Data Output

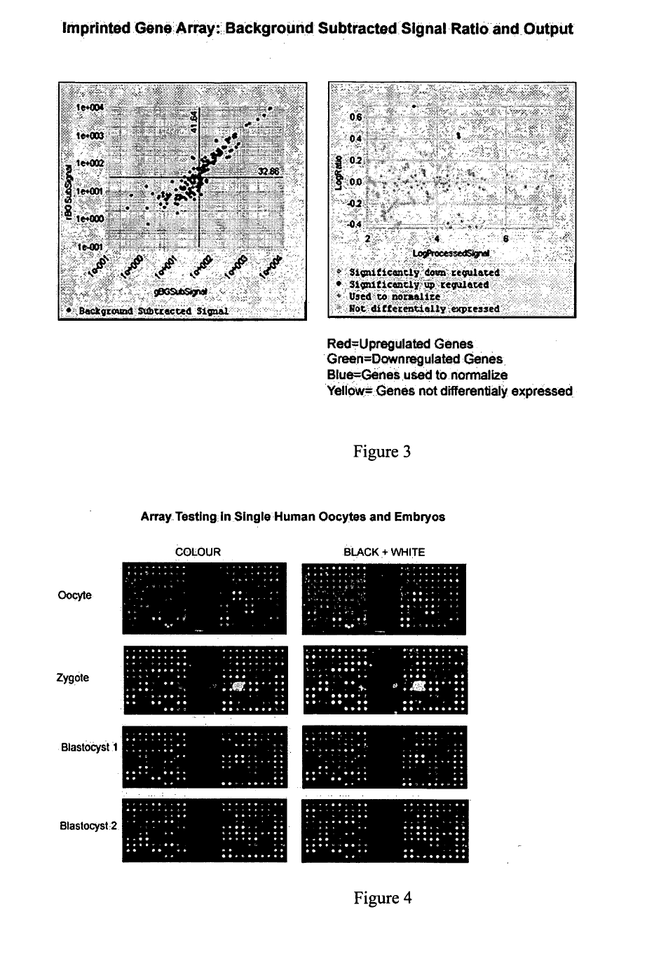

An expected straight line graph is produced when analyzing the background-subtracted signal ratio from two differently labelled tissues hybridised on the array FIG. 3 (left). The differentially expressed genes are identified in FIG. 3 (right).

### Example 4

### Testing in Single Human Oocytes and Preimplantation Embryos

Over 40 single human oocytes or preimplantation embryos of various stages have individually been tested successfully on the array, proving the device is sufficiently sensitive to detect imprinted gene expression with a high degree of sensitivity. Dynamic regulation of imprinted gene expression are observed for these stages of development. Between 25 and 30 imprinted genes are expressed in the human blastocyst (FIG. 4).

### Example 5

### Verification of Differentially Expressed Genes by Semi-Quantitative PCR

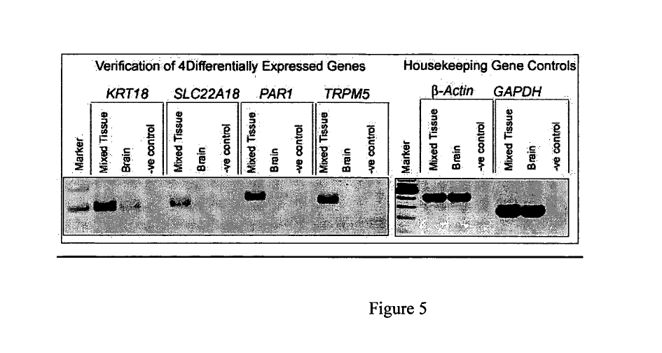

The imprinted gene microarray was used in a series of replicate experiments (including dye-swaps) comparing expression in brain versus mixed tissue. Genes that were revealed to be consistently differentially expressed between brain and mixed tissue samples were subjected to verification by Semi-Quantitative RT-PCR. Results were consistent with array data. Four of the genes up-regulated in mixed tissue relative to brain are shown below. ASLC22A18, PAR1 and TRPM5 are imprinted genes (FIG. 5).

### Example 6

### Tables

Table I: illustrates human imprinted genes affected by Assisted Reproduction and resulting diseases as determined by the analysis of the use of ART in imprinted disease cohorts.
Table II: illustrates experimental data for mammalian imprinted genes and epigenetic regulators that are affected by assisted reproduction, and the underlying cause or molecular defects incurred.
Table III: illustrates data for disruption of imprinted gene expression in cloned assisted reproduction of mammalian, such as human, embryos, and stem cells that are derived somatic cell nuclear transfer and related technologies and the underlying cause or molecular defects incurred.

TABLE I
Human Imprinted Genes Affected by Assisted Reproduction, and
Resulting Diseases.

| | | | Imprinted | |
|---|---|---|---|---|
| | | | Gene(s) | |
| | Imprinted Disease | ART procedure | affected | Type of genetic defect |
| IMPRINTING | Beckwith- | IVF and ICSI | KCNQ1OT1, | KCNQ1OT1 |
| DISORDERS | Wiedemann | | H19 | Hypomethylation, H19 |
| | syndrome (BWS) | | | hypermethylation |
| | (BWS) | IVF and ICSI | KCNQ1OT1 | LIT1 Hypomethylation |
| | BWS | IVF and ICSI | KCNQ1OT1 | LIT1 Hypomethylation |
| | BWS | ICSI | n.d | n.d |
| | BWS | IVF and ICSI | n.d | n.d |
| | BWS | IVF and ICSI | n.d | n.d |
| | BWS | IVF | n.d | n.d |
| | BWS | IVF | n.d | n.d |
| | BWS | ART | KCNQ1OT1 | loss of methylation at |
| | | | and multiple | KCNQ1OT1 and other |
| | | | imprinted loci | defects |
| | | | outside of | |
| | | | chromosome | |
| | | | 11 | |
| | Not determined, but | ICSI/ROSI) | H19 | Aberrant methylation of |
| | BWS may be | using sperm | | H19 in oligozoospermic |
| | implicated | from | | males |
| | | oligozoospermic | | |
| | | males. | | |
| | Angelman syndrome | ICSI | SNRPN | (epimutation in |
| | (AS) | | | imprinting control region) |
| | AS | ICSI | SNRPN | (epimutation in |
| | | | | imprinting control region) |
| | Silver-Russell | IVF | PEG1/MEST | |
| | syndrome | | | |

TABLE II
Disruption of Imprinted Gene Expression and, epigenetic regulation
following Assisted Reproduction of Mammalian Gametes and Embryos.

| | | | Affected Gene | |
|---|---|---|---|---|
| | | | or Epigenetic | |
| Cell Type | ART Technique | Species | Mark | Comments |
| PREIMPLANTATION | Culture Media | Mouse | H19, Igf2 | Aberrant expression due to presence of FCS in |
| EMBRYOS | | | | M16 culture medium. |
| | Culture Media | Mouse | H19 | Loss of H19 imprinting in extraembryonic |
| | | | | tissues |
| | Culture. Media | Mouse | H19 | Loss of H19 methylation upon culture in |
| | | | | Whitten's medium. |
| | Culture Media | Mouse | Igf2 | Aberrant expression bias to maternal allele in |
| | | | | preimplantation embryo |
| | Culture Media | Mouse | H19 | High levels of ammonium causes aberrant |
| | | | | expression of H19 |
| | Culture Media | Mouse | Igf2, Meg1 and | Reduced expression of three imprinted genes |
| | | | Peg1 | after culture with FCS |
| | Culture Media | Mouse | H19, Igf2 | Quinn's medium causes aberrant H19 |
| | | | | expression in embryos, aberrant H19 and Igf2 |
| | | | | in ES cells |
| | In vitro culture | Sheep | Igf2r | Reduced expression and methylation of Igf2r |
| | | | | in a Large Offspring Syndrome model |
| | In vitro | Cow | Igf2, Igf2r | Reduced expression in in vitro produced |
| | development | | | embryos compared to in vivo embryos |
| | In vitro culture | Mouse | Dnmt1 | Increased Dnmt1 expression in in vitro |
| | | | | produced blastocysts |
| | Culture Media | Cow | Dnmt1, Mash2 | Increased Dnmt1 expression, decreased Mash2 |
| | | | | in in vitro produced blastocysts |
| | In vitro | Mouse, | DNA | Increased DNA methylation compared to in |
| | development | rat | methylation | vivo embryos |
| | Culture Media | Cow | Dnmt3a, Igf2r | Upregulated expression of Dnmt3a and Igf2r |
| | | | | in CR1aa and KSOMaa respectively |
| SPERM | ROSI | Mouse | H19 | Altered expression of H19 in extraembryonic |
| | | | | tissues |
| | ROSI | Mouse | Histone | Significant difference in DNA methylation |
| | | | methylation | and histone methylation dynamics compared |
| | | | | to ICSI embryos |
| | ROSI | Mouse | DNA | Abnormal localization of methylated |
| | | | methylation | chromatin in male pronucleus in fertilised |
| | | | | oocytes derived from ROSI |
| OOCYTES | In vitro growth of | Mouse | Igf2r, Peg1, H19 | Loss of methylation at Igf2R and Peg1. Gain |
| | follicles | | | of methylation at H19 |
| | In vitro maturation | Mouse | Peg1 | In vitro culture for 8 h, Peg1/Mest DMR |
| | | | | becomes fully methylated. Demethylation |
| | | | | may occur after culture for 28 hrs in vitro |
| | In vitro maturation | Human | HI 9 | Abnormal methylation at H19 locus |
| | Superovulation | Mouse | DNA | Global methylation abnormalities |
| | | | methylation | |
| | Superovulation | Human | H19, PEG1 | Aberrant gain of methylation at H19. loss of |
| | | | | methylation at the PEG1 gene |
| | Cause not | Human | KvDMR1 | Failure to establish methylation imprint at |
| | identified | | | KvDMR1 in a MI oocyte |

TABLE III
Disruption of Imprinted Gene Expression in Cloned Mammalian
Embryos, and Embryonic Stem Cells.

| | | IMPRINTED | |
|---|---|---|---|
| | Technique/ | Gene(s) | |
| | study focus | affected | Comments |
| Cloned | SCNT | Imprinting | Disruptions in total transcript abundance |
| Preimplantation | | control regions | and allele specificity of expression for five |
| embryos | | of the H19 and | imprinted genes in cloned blastocysts. Loss |
| | | Snprn genes | of allele-specific DNA methylation at H19 |
| | | | and Snprn genes |
| | SCNT | U2af1-rs1, | Loss of methylation and biallelic expression |
| | | Igf2, H19, | of U2af1-rs1, maternal methylation and |
| | | Igf2r | predominantly maternal expression of Igf2, |
| | | | and biallelic methylation and expression of |
| | | | Igf2r. Biallelic repression of H19 |
| | SCNT | Genome-wide | Aberrant methylation reprogramming in |
| | | study | cloned preimplantation embryos. |
| Embryonic | Cell culture | IGF2, H19 | Aberrant methylation and aberrant |
| Stem Cells | (after SCNT) | | (increased) expression of IGF2 and H19 |
| | | | associated with serum depletion and high |
| | | | density culture |
| | SCNT | IGF2, H19 | Significant variation in expression of H19 |
| | | | and IGF2 in ES cells and also in the |
| | | | placentas of foetuses derived from these ES |
| | | | cells |
| | SCNT | H19, IGF2, | Altered expression and methylation of H19 |
| | | IGF2R | IGF2 AND IGF2R in cloned embryos |
| | | | derived from ES cells |

1. A gene expression array comprising more than one imprinted gene and one or more control genes.

2. A gene expression array according to claim 1 wherein the number of imprinted genes in the array makes up from 60 to 80% of the total array.

3. A gene expression array according to claim 1 wherein the number of imprinted genes in the array makes up from 65 to 75% of the total array.

4. A gene expression array according to claim 1 wherein the number of imprinted genes in the array makes up 72% of the total array.

5. A gene expression array according to claim 1 wherein the more than one imprinted genes are selected from any known/predicted human imprinted genes across the imprinted regions on human chromosomes 1, 6, 7, 11, 12, 13, 14, 15, 18, 19, 20 and X.

6. A gene expression array according to claim 1 wherein the more than one imprinted genes are selected for the diagnosis of human epigenetic diseases resulting from assisted reproduction or the disruption of imprinted gene expression in assisted reproduction and/or in vitro production and culture of mammalian gametes, embryos, stem cells, stem cell lines, somatic cell lines, therapeutic stem cells, birth defects, mental retardation, obesity, gross motor disturbances, diabetes molar pregnancy, disorders of genomic imprinting, other epigenetic diseases.

7. A gene expression array according to claim 1 wherein the gene expression array is used for the diagnosis of disease resulting from assisted reproduction.

8. A gene expression array according to claim 1 wherein the gene expression array is used for the diagnosis of disease resulting from the disruption of imprinted gene expression in assisted reproduction of mammalian embryos and/or stem cells,

9. A gene expression array according to claim 1 wherein the more than one imprinted genes are selected from H19, KCNQ1OT1, SNRPN, PEG1/MEST and IGF2.

10. A gene expression array according to claim 1 wherein the gene expression the more than one imprinted gene is selected from H19, IGF2, MEG1, H19, KCNQ1OT1, SNRPN and PEG1/MEST.

11. A gene expression array according to claim 1 wherein the one or more control genes is a non-imprinted control gene which is positioned within or adjacent to the imprinted region.

12. A gene expression array according to claim 1 wherein additional control genes are “housekeeping” control genes.

13. A gene expression array according to claim 1 wherein the control genes make up from 10 to 20% of the total array.

14-15. (canceled)

16. A gene expression array according to claim 1 wherein the control genes are predominantly made up of imprint region controls.

17. A gene expression array according to claim 1 wherein the imprint region control comprises 50% or more of the total control gene population.

18. A gene expression array according to claim 1 wherein the array includes one or more epigenetic regulator genes.

19. A gene expression array according to claim 1 wherein the number of epigenetic regulators make up from 5 to 15% of the total array.

20-21. (canceled)

22. A method of detecting the presence of a disease in a subject which comprises obtaining a biological sample from the subject and screening the sample for abnormal imprinting in more than one gene simultaneously.

23. A method according to claim 22 which comprises the use of a gene expression array comprising more than one imprinted gene and one or more control genes.

24-26. (canceled)
